(19) United States
(12) Patent Application Publication
(10) Pub. No.: US 2003/0002604 A1
(43) Pub. Date: Jan. 2, 2003

(54) Frequency offset diversity receiver

(75) Inventors: Robert Fifield, Redhill (GB); David H. Evans, Crawley (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/180,618

(22) Filed: Jun. 26, 2002

(30) Foreign Application Priority Data
Jun. 27, 2001 (GB) 0115628.0
Dec. 5, 2001 (GB) 0129077.4

(51) Int. Cl. H04B 7/10

(52) U.S. Cl. 375/347

(57) ABSTRACT

A frequency offset diversity receiver comprises a first RF receiver branch (10) and a second RF receiver branch (12), an RF signal combiner (14) having first and second inputs (11,13) and an output, the first and second receiver branches being coupled to the first and second inputs (11,13), respectively, frequency shifting means (26) in the second receiver branch (12) for shifting a received signal frequency by at least one channel bandwidth, an intermediate frequency (IF) stage (28,30) coupled to the output of the signal combining means (14) for converting the combined RF signal to baseband, frequency demultiplexing means (36) for recovering the baseband signals corresponding to the RF signals received by the first and second receiver branches (10,12) and a baseband signal combiner (42) for combining the demultiplexed signals to provide an output signal (44).

The baseband signal combiner in one embodiment comprises at least one MIMO stage.

The present invention relates to a frequency offset diversity receiver and has particular, but not exclusive, application to multiple input multiple output (MIMO) systems, such as HIPERLAN 2 systems, and receiver systems using antenna diversity.

A frequency offset diversity receiver is known from IEEE Transactions on Vehicular Technology, Vol. VT-36, No. 2, May 1987, beginning at page 63, “Frequency Offset Receiver Diversity for Differential MSK” by Tatsuro Masamura. The described receiver diversity scheme is intended for the differential detection of MSK (Minimum Shift Keying) in a high quality mobile satellite communications system. The receiver comprises two receiving branches each having its own antenna. The signal from each receiving branch is translated to a different intermediate frequency (IF). The IF signals are summed and then detected by a common differential detector. The plurality of signals are combined at an IF stage without phase adjusters, signal quality measurement circuits or a switching controller. The IF signals differ in frequency by the carrier frequency offset fₛ. The frequency offset is chosen to be sufficiently large that any interference components in the products of mixing can be suppressed by a low pass filter following the differential detector. Each of the receiving branches effectively comprises two complete receiver chains which not only raises the component count and thereby the cost but also increases the power consumption which is undesirable in hand portable units.

An object of the present invention to reduce the component count in frequency offset diversity receivers.

According to the present invention there is provided a frequency offset diversity receiver having means for combining at least two modulated RF input signals to form a single RF offset diversity signal, a receive chain for converting the single RF signal to a baseband signal, means for frequency demultiplexing the baseband signal to provide the respective modulated baseband signals, and means for combining the demultiplexed signals to provide an output.

The present invention also provides a frequency offset diversity receiver comprising spatial diversity means for picking-up respective ones of at least two modulated RF input signals, RF signal combining means having signal inputs and an output, the signal inputs being coupled to the spatial diversity means, RF offset diversity means in signal paths of all but one modulated RF input signals to shift the respective RF input signals into respective frequency channels adjacent a frequency channel containing said one of the modulated RF signals, an intermediate frequency (IF) stage coupled to the output of the signal combining means for mixing the combined signals down to baseband, frequency demultiplexing means coupled to the IF stage for recovering the respective baseband modulated signals and means for combining the demultiplexed signals to provide an output signal.

Unlike the known type of receiver described above, the input signals are essentially at RF when they are combined thus avoiding a duplication of components in the RF section of the receiver and their attendant cost. Frequency down conversion to baseband is done in a common stage and thereafter the signals which have been digitised undergo frequency demultiplexing to recover the originally received signals which are subsequently combined.

The present invention will now be described, by way of example, with reference to the accompanying drawings, in which:

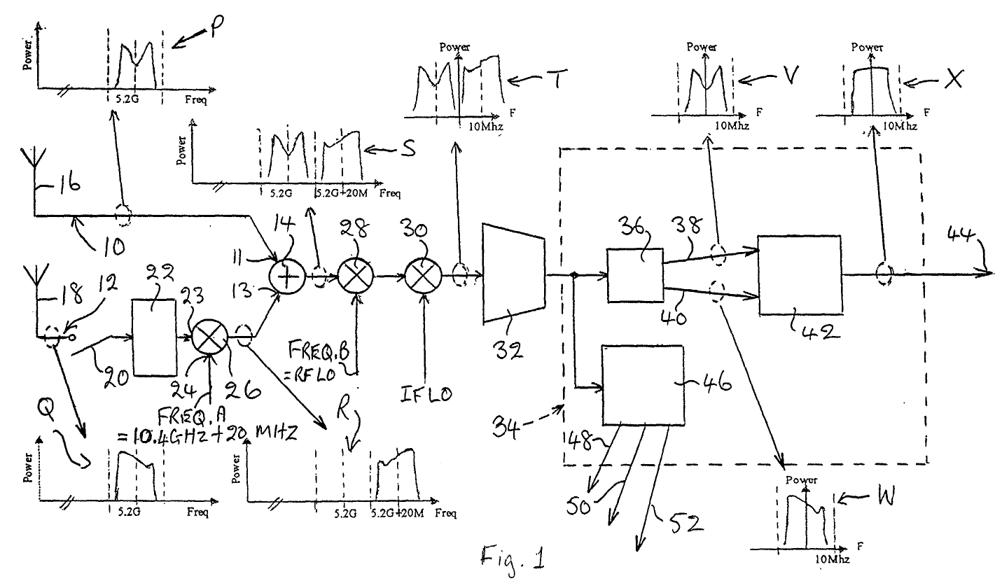

FIG. 1 is a block schematic diagram of a frequency offset diversity receiver made in accordance with the present invention, and

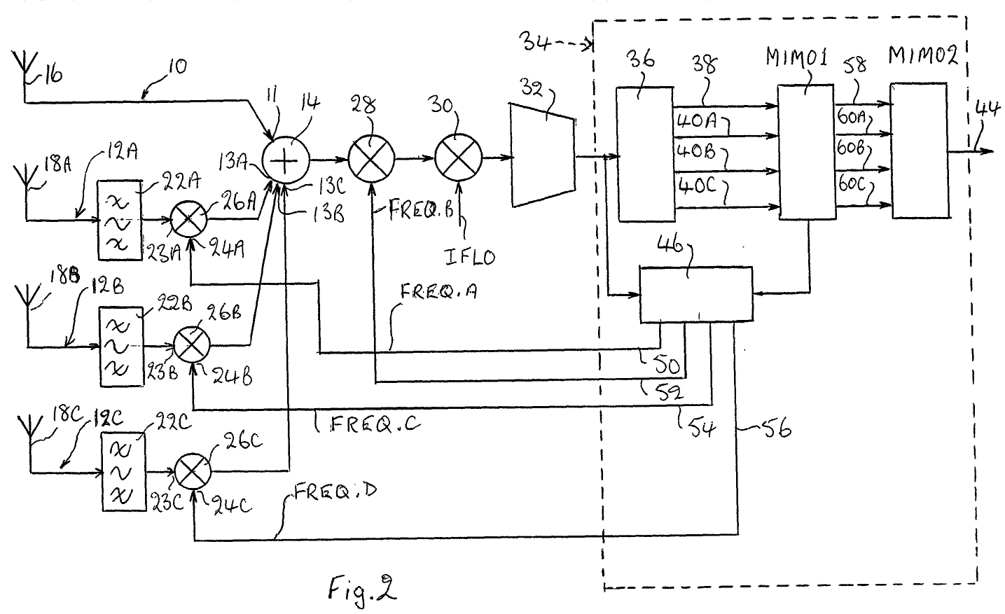

FIG. 2 is a block schematic diagram of a MIMO receiver.

In the drawings the same reference numerals have been used to refer to corresponding features.

The receiver shown in FIG. 1 comprises first and second RF receiving branches 10, 12 which are coupled to respective inputs 11, 13 of a combiner 14. The first receiving branch 10 comprises a first antenna 16 which is coupled to the input 11 of the combiner 14. The second branch 12 comprises a second antenna 18 which is spatially separated from the first antenna 16, and which is coupled by way of a switch 20 to a filter 22. An output of the filter 22 is coupled to a first input 23 of a mixer 26. A local oscillator signal having a frequency FREQ.A is supplied to an input 24 of the mixer 26 in order to shift the signal on the first input 23 to a frequency channel adjacent the channel occupied by the signal in the first receiving branch 10. An output of the mixer 26 is supplied to the input 13 of the combiner 14.

The combined signal output of the combiner 14 is frequency down-converted to baseband in two heterodyning stages which include a RF mixer 28, which receives a RF local oscillator frequency FREQ.B from a suitable source to frequency down-convert the combined RF signal to an IF, and an IF mixer 30, which receives an IF local oscillator frequency to frequency down-convert the IF signal on its other input to baseband.

Optionally a single mixer (not shown) may be substituted for the mixers 28 and 30 in which case its local oscillator frequency is selected to convert the combined RF signal to baseband.

An analogue to digital converter (ADC) 32 digitises the baseband signal from the mixer 30 and supplies it to a baseband processing stage 34. The stage 34 comprises a frequency demultiplexer 36 which recovers the respective original modulating signals received by the first and second branches 10, 12 and provides them on respective outputs 38, 40. The signal on the output 40 has had the frequency shift produced by the mixer 26 reversed. These outputs 38, 40 are coupled to a phase align and combine stage 42 which provides a single maximally combined signal on an output 44.

The baseband processing stage 34 includes a scan adjacent channel stage 46 which has an input coupled to the output of the ADC 32. The stage 46 has three outputs 48, 50 and 52. The output 48 is used for selectively operating the switch 20, the output 50 provides the frequency FREQ.A which is used to shift the frequency of the RF signal in the second receiving branch 12, and the output 52 provides the frequency FREQ.B to the local oscillator input of the RF mixer 28.

The operation of the illustrated receiver will now be described with the assistance of the inset waveform diagrams P, Q, R, S, T, V, W and X. In the diagrams the abscissa represents frequency and the ordinate represents power.

Diagram P illustrates a single channel signal received by the first antenna 16 and diagram Q illustrates a single channel signal received by the second antenna 18. Both the channels are centred on 5.2 GHz. Diagram R illustrates the signal which has been received by the second antenna 18 shifted in frequency by +20 MHz so as to lie in a channel adjacent to that occupied by the signal on the first antenna 16. The combined signal from the stage 14 is shown in diagram S which shows these signals located in adjacent frequency diversity channels.

Diagram T shows the combined signals frequency down-converted to baseband. Diagrams V and W show the respective outputs 38, 40 from the frequency demultiplexer 36. In the case of the diagram W, the signal has been shifted back in frequency and resembles that shown in the diagram Q. Finally diagram X shows the result of phase aligning and combining the signals shown in diagrams V and W into a single, largely undistorted pulse.

In a preferred mode of operation, both adjacent channels are empty in which case the switch 20 is closed and both signals are used. However if both of the adjacent channels are occupied, the receiver cannot operate with two frequency multiplexed signals and the switch 20 is opened so that the receiver operates as an ordinary receiver which may still employ antenna switching similar to a classic receiver with antenna diversity.

In the event of only one of the channels being occupied, the receiver may still employ frequency multiplexing but may need to adjust the frequencies FREQ.A and FREQ.B in order that the frequency multiplexed signal is not corrupted.

The illustrated receiver can investigate the status of the adjacent channels by baseband processing. In order to do this the switch 20 is opened and the signal strengths of the demultiplexed signals are compared. To investigate the other adjacent channel, the frequencies FREQ.A and FREQ.B will have to be adjusted.

In a non-illustrated variant of the receiver made in accordance with the present invention, the frequency multiplexing could be carried out at IF after the IF channel filter. This will ensure that adjacent channels would always be empty. This non-illustrated variant would require two RF to IF frequency down-converters but only one IF to baseband frequency down-converter.

The signal in the second receiving branch 12 may be shifted by more than one channel spacing. In such a case the IF stage and the ADC 36 will have to operate over a greater frequency range.

FIG. 2 shows an embodiment of a frequency offset receiver for use in a MIMO system. The illustrated MIMO receiver is in many respects a simple extrapolation of the receiver shown in FIG. 1 having more channels or branches. Although four receiving branches have been shown in FIG. 2, the number is repeated to provide enough branches for the total number of MIMO branches.

The receiver shown in FIG. 2 comprises four receiving branches (or channels) 10, 12A, 12B and 12C which are coupled to respective inputs 11, 13A, 13B and 13C of a combiner 14. A first of the receiving branches, branch 10, comprises a first antenna 16 which is coupled to the input 11 of the combiner 14. The architecture of the remaining three branches 12A, 12B and 12C is substantially the same and for convenience of description only the second branch 12A will be described. The corresponding features in the third and fourth branches 12B and 12C will referred to in parentheses.

The second branch 12A comprises an antenna 18A (18B, 18C) which is coupled to a filter 22A (22B, 22C). An output of the filter 22A (22B, 22C) is coupled to a first input 23A (23B, 23C) of a mixer 26A (26B, 26C). A local oscillator signal having a frequency FREQ.A (FREQ.C and FREQ.D) is supplied to an input 24A (24B, 24C) of the mixer 26A (26B, 26C) in order to shift the signal on the first input 23A (23B, 23C) to a frequency channel adjacent or close to the channel occupied by the signal in the first receiving branch 10. An output of the mixer 26A (26B, 26C) is coupled to a respective input 13A (13B, 13C) of the combiner 14. By way of example the first channel 10 has a centre frequency of 5.2 GHz and the respective local oscillator signals applied to the inputs 24A, 24B and 24C of the mixers 26A, 26B, 26C are such that the respective signals applied to the inputs 13A, 13B and 13C of the combiner 14 are [5.25 GHz+(1×20 MHz)], [5.2 GHz+(2×20 MHz)] and [5.2 GHz−(1×20 MHz)].

The combined signal output of the combiner 14 comprising signals in four adjacent frequency channels is frequency down-converted to baseband in two heterodyning stages which include a RF mixer 28 which receives a RF local oscillator frequency FREQ.B from a suitable source for frequency down-converting the combined RF signal to an IF and an IF mixer 30 which receives an IF local oscillator frequency for frequency down-converting the IF signal on its other input to baseband.

Optionally a single mixer (not shown) may be substituted for the mixers 28 and 30 in which case its local oscillator frequency is selected to convert the combined RF signal to baseband.

An analogue to digital converter (ADC) 32 digitises the baseband signal from the mixer 30 and supplies it to a baseband processing stage 34. The stage 34 comprises a frequency demultiplexer 36 which recovers the respective original modulating signals received by the four branches 10, 12A, 12B and 12C and provides them on respective outputs 38, 40A, 40B and 40C. The signals on the outputs 40A, 40B and 40C have had the frequency shifts produced by the mixers 26A, 26B and 26C reversed. These outputs 38, 40A, 40B and 40C are coupled to a first MIMO stage MIMO1. The MIMO1 stage is capable of carrying out some or all of the following elements or functions:

(a) Radio channel estimation (to determine the coefficients of the M by N matrix that represents the performance of the channel where M is the number of transmitters and N is the number of receivers. This can be achieved by the use of either training sequences or coding techniques.).

(b) Radio channel matrix inversion.

(c) Capacity estimation.

(d) Nulling or beam forming.

(e) Interference cancellation.

(f) Maximising SNR.

(g) Error detection and correction.

Outputs 58, 60A, 60B and 60C of the MIMO1 stage are coupled to respective inputs of a second MIMO stage MIMO2 which is a multiplexer for recombining the individual data streams into a common stream which is supplied on an output 44.

The baseband processing stage 34 includes a scan adjacent channel stage 46 which has an input coupled to the output of the ADC 32. The stage 46 has four outputs 50, 52, 54 and 56. The output 50 provides the frequency FREQ.A which is used to shift the frequency of the RF signal in the second receiving branch 12A, the output 52 provides the frequency FREQ.B to the local oscillator input of the RF mixer 28, and the outputs 54, 56 respectively provide FREQ.C and FREQ.D for shifting the frequencies of the RF signals in the third and fourth receiving branches 12B, 12C.

Comparing FIGS. 1 and 2 it will be noted that FIG. 2 there are no switches in the branches 12A, 12B and 12C because the multi-branch structure of MIMO must be available at all times for MIMO to operate. Nevertheless there may be occasions when some of the adjacent channels are occupied and the transmitter needs to be informed. This can be done by way of a reverse channel and the transmitter can in response limit the degree of MIMO increase which it is using.

In the present specification and claims the word “a” or “an” preceding an element does not exclude the presence of a plurality of such elements. Further, the word “comprising” does not exclude the presence of other elements or steps than those listed.

1. A frequency offset diversity receiver having means for combining at least two modulated RF input signals to form a single RF offset diversity signal, a receive chain for converting the single RF signal to a baseband signal, means for frequency demultiplexing the baseband signal to provide the respective modulated baseband signals, and means for combining the demultiplexed signals to provide an output.

2. A receiver as claimed in claim 1, characterised in that the means for combining the at least two modulated RF input signals comprises means for shifting the frequency of at least one of the at least two input signals to a channel adjacent the other of the at least two modulated RF input signals.

3. A receiver as claimed in claim 1 or 2, characterised by spatial diversity means for picking-up the at least two modulated RF input signals.

4. A receiver as claimed in claim 1, 2 or 3, characterised in that the means for combining the frequency demultiplexed signals includes phase aligning means.

5. A receiver as claimed in claim 1, 2 or 3, characterised in that the means for combining comprises a first MIMO stage for combining at least two input signals into a single output and in that a second MIMO stage is coupled between the frequency demultiplexing means and the first MIMO stage.

6. A frequency offset diversity receiver comprising spatial diversity means for picking-up respective ones of at least two modulated RF input signals, RF signal combining means having signal inputs and an output, the signal inputs being coupled to the spatial diversity means, RF offset diversity means in signal paths of all but one modulated RF input signals to shift the respective RF input signals into respective frequency channels adjacent a frequency channel containing said one of the modulated RF signals, an intermediate frequency (IF) stage coupled to the output of the signal combining means for mixing the combined signals down to baseband, frequency demultiplexing means coupled to the IF stage for recovering the respective baseband modulated signals and means for combining the demultiplexed signals to provide an output signal.

7. A receiver as claimed in claim 6, characterised in that the means for combining the frequency demultiplexed signals includes phase aligning means.

8. A receiver as claimed in claim 6, characterised in that the means for combining comprises a first MIMO stage for combining at least two input signals into a single output and in that a second MIMO stage is coupled between the frequency demultiplexing means and the first MIMO stage.

9. A receiver as claimed in claim 6, characterised by switching means coupled to each of the RF offset diversity means and means responsive to detecting that at least two adjacent frequency channels are already in use, for operating the switching means to interrupt the signal path.

10. A receiver as claimed in claim 6, characterised by means for detecting the status of the adjacent frequency channels, said means causing the RF frequency offset diversity means and the IF stage to adjust their frequencies to avoid corruption of the combined signal.
